(19) United States
(12) Patent Application Publication
(10) Pub. No.: US 2002/0129709 A1
(43) Pub. Date: Sep. 19, 2002

(54) Storage device utilizing a differentially permeable membrane to control gaseous content

(76) Inventors: Lawrence Kunstadt, Ardsley, NY (US); Peter Carlson, Chevy Chase, MD (US)

Correspondence Address: ST. ONGE STEWARD JOHNSTON & REENS, LLC, 986 BEDFORD STREET, STAMFORD, CT, 06905-5619, US

(21) Appl. No.: 10/093,678

(22) Filed: Mar. 8, 2002

Related U.S. Application Data
(60) Provisional application No. 60/275,397, filed on Mar. 13, 2001.

(51) Int. Cl. B01D 53/22

(52) U.S. Cl. 96/4; 55/385.2; 55/385.4

(57) ABSTRACT

A storage device for the preservation of oxidizable materials is provided. The storage device includes a storage chamber enclosing a storage space where oxidizable materials may be placed, the storage chamber having at least one fluid passage therethrough from the storage space to atmosphere. At least one differentially permeable membrane is disposed within at least one of the fluid passages, the differentially permeable membrane allowing at least one selected gas to pass therethrough while inhibiting at least one other selected gas from passing therethrough. An evacuator evacuates oxygen from within the storage chamber through at least one of the fluid passages to the atmosphere such that the level of oxygen within the storage chamber is reduced relative to the level of oxygen in the atmosphere.

### CROSS-REFERENCE TO RELATED APPLICATIONS

This application claims the benefit of, under 35 U.S.C. 119(e), U.S. Provisional Patent Application No. 60/275,397, filed Mar. 13, 2001.

### FIELD OF THE INVENTION

This invention relates to a storage device, and more specifically to a long-term storage device for oxidizable materials which controls the gaseous content of a storage volume of the device in order to prolong storage life, allow storage of currently difficult-to-store materials and to inhibit the ripening and/or deterioration of certain foods.

### BACKGROUND OF THE INVENTION

Refrigerated devices are well known and widely utilized to increase the storage life of items to be stored, such as food items. As an example, a refrigerator commonly used in most households in the United States increases the storage life of many foods by maintaining the temperature well below room temperature, thereby slowing the natural ripening and oxidation processes. However, such devices suffer from a number of disadvantages, including complexity, weight and cost.

Moreover, refrigerated devices can be noisy and generate a great amount of heat, which may be undesirable in many circumstances. Furthermore, refrigeration devices are generally not energy efficient, and thus such devices are typically costly to operate and environmentally unfriendly. Furthermore, refrigeration devices may not be appropriate for storing all food items (e.g., apples may lose their taste when cold, bananas may turn black, etc.). Another problem with refrigeration devices is that they may not be appropriate for storing many non-food items (e.g., documents, stamps, coins, etc.) due to moisture problems.

Another type of storage device which has been developed is a vacuum storage device, which operates by creating a vacuum within a storage volume of the device in order to remove oxygen therefrom, and extend the storage life of oxidizable materials. Although such devices obviate some of the disadvantages of refrigeration devices (i.e., the problems associated with storing certain food items in a cold environment and the moisture problems), vacuum devices do not remedy a number of the other problems. Vacuum storage devices are typically even more complex, heavy and costly to produce than refrigeration devices, which is why such vacuum devices are typically used only in industrial settings. These devices are typically large and may pose a safety problem, as it has been known that persons may become trapped within such devices, and be injured or killed because of the vacuum created therein.

Furthermore, the vacuum pumps used with vacuum storage devices can be noisy and are generally not energy efficient, thereby making vacuum storage devices costly to operate and environmentally unfriendly. Moreover, vacuum storage devices suffer from a number of additional disadvantages. In addition to requiring a costly vacuum pump, the storage volume itself is also costly. This is true because, due to the vacuum created, a structurally heavy storage volume is required so as to inhibit implosion or collapsing thereof due to the vacuum formed therein. Moreover, a complex and expensive sealing means is required so that the storage volume can hold a vacuum. Moreover, despite the precautions taken, there is a very real possibility that implosion may occur and/or that a vacuum may not be held.

Yet another type of storage device which has been developed is an inert gas pumping system. In these devices, an inert gas environment is artificially maintained within a storage volume by pumping an inert gas, such as nitrogen, into the storage volume, thereby displacing the normal atmospheric content (including oxygen) to maintain and prolong the storage life of oxidizable items stored therein. However, these devices are typically even more costly and complex than refrigeration and vacuum systems, and are therefore generally used only to store rare documents, stamps, coins, and/or other valuable materials. A further disadvantage of these types of systems is that it is necessary to provide, and to replace on a regular basis, cylinders of inert gas, which can be costly and burdensome, and which renders such devices appropriate only for large-scale industrial use (as opposed to home use).

What is desired, therefore, is a storage device for oxidizable materials which controls the gaseous content of a storage volume of the device in order to prolong storage life, to allow storage of currently difficult-to-store materials, to allow storage of non-refrigeratable foods and to inhibit the ripening and/or deterioration of certain foods without adversely affecting flavor, which is relatively simple in design, lightweight and inexpensive to produce, which operates quietly and does not generate a great amount of heat, which is appropriate for storing substantially all oxidizable food items and non-food items, which is energy efficient and therefore relatively inexpensive to operate and environmentally friendly, which does not risk implosion, and which does not require servicing and/or the replacement of components on a regular basis.

### SUMMARY OF THE INVENTION

Accordingly, it is an object of the present invention to provide a storage device for oxidizable materials which controls the gaseous content of a storage volume of the device in order to prolong storage life, to allow storage of currently difficult-to-store materials, to allow storage of non-refrigeratable foods and to inhibit the ripening and/or deterioration of certain foods without adversely affecting flavor.

Another object of the present invention is to provide a storage device for oxidizable materials having the above characteristics and which is relatively simple in design, lightweight and inexpensive to produce.

A further object of the present invention is to provide a storage device for oxidizable materials having the above characteristics and which operates quietly and does not generate a great amount of heat.

Still another object of the present invention is to provide a storage device for oxidizable materials having the above characteristics and which is appropriate for storing substantially all oxidizable food items and non-food items.

Yet a further object of the present invention is to provide a storage device for oxidizable materials having the above characteristics and which is energy efficient and therefore relatively inexpensive to operate and environmentally friendly.

Still yet a further object of the present invention is to provide a storage device for oxidizable materials having the above characteristics and which does not risk implosion.

Yet another object of the present invention is to provide a storage device for oxidizable materials having the above characteristics and which does not require servicing and/or the replacement of components on a regular basis.

These and other objects of the present invention are achieved by provision of a storage device for the preservation of oxidizable materials. The storage device includes a storage chamber enclosing a storage space where oxidizable materials may be placed, the storage chamber having at least one fluid passage therethrough from the storage space to atmosphere. At least one differentially permeable membrane is disposed within at least one of the fluid passages through the storage chamber, the differentially permeable membrane allowing at least one selected gas to pass therethrough while inhibiting at least one other selected gas from passing therethrough. An evacuator evacuates oxygen from within the storage chamber through at least one of the fluid passages to the atmosphere such that the level of oxygen within the storage chamber is reduced relative to the level of oxygen in the atmosphere.

In one embodiment, the at least one fluid passage comprises an inlet fluid passage and an outlet fluid passage. The differentially permeable membrane is disposed within the inlet fluid passage and allows at least one gas to pass therethrough while inhibiting at least oxygen from passing therethrough. The evacuator evacuates gasses, including oxygen, from within the storage chamber through the outlet fluid passage, and gasses other than oxygen replace the gasses evacuated by the evacuator by passing through the differentially permeable membrane disposed in the inlet fluid passage until the level of oxygen within the storage chamber is greatly reduced. In this embodiment, a one-way check valve is preferably disposed within the outlet fluid passage to inhibit gasses from flowing into the storage chamber through the outlet fluid passage. Most preferably, the differentially permeable membrane allows at least nitrogen to pass therethrough while inhibiting at least oxygen from passing therethrough.

In another embodiment, the at least one fluid passage comprises an outlet fluid passage. The differentially permeable membrane is disposed within the outlet fluid passage and allows at least oxygen to pass therethrough while inhibiting at least one other gas from passing therethrough. The evacuator evacuates at least oxygen from within the storage chamber through the differentially permeable membrane disposed in the outlet fluid passage. Most preferably, the differentially permeable membrane allows at least oxygen to pass therethrough while inhibiting at least nitrogen from passing therethrough.

In both embodiments, the evacuator preferably comprises either a fan or a compressor. The differentially permeable membrane may take any of a number of forms, including a substantially flat sheet of material or cartridge, or a substantially cylindrical hollow fiber cartridge. Preferably, a gauge is provided for monitoring the level of oxygen within the storage chamber. Most preferably, the gauge is used to selectively switch the evacuator on or off depending upon the oxygen level within the storage chamber in order to conserve energy.

The invention and its particular features and advantages will become more apparent from the following detailed description considered with reference to the accompanying drawings.

### BRIEF DESCRIPTION OF THE DRAWINGS

FIG. 1 is a perspective view of an embodiment of a storage device for oxidizable materials in accordance with the present invention;

FIG. 2 is a cross-sectional view of the embodiment of a storage device for oxidizable materials shown in FIG. 1;

FIG. 3 is a cross-sectional view of a second embodiment of a storage device for oxidizable materials in accordance with the present invention;

FIG. 4 is a perspective view of a third embodiment of a storage device for oxidizable materials in accordance with the present invention; and

FIG. 5 is a cross-sectional view of the embodiment of a storage device for oxidizable materials shown in FIG. 4;

### DETAILED DESCRIPTION OF THE INVENTION

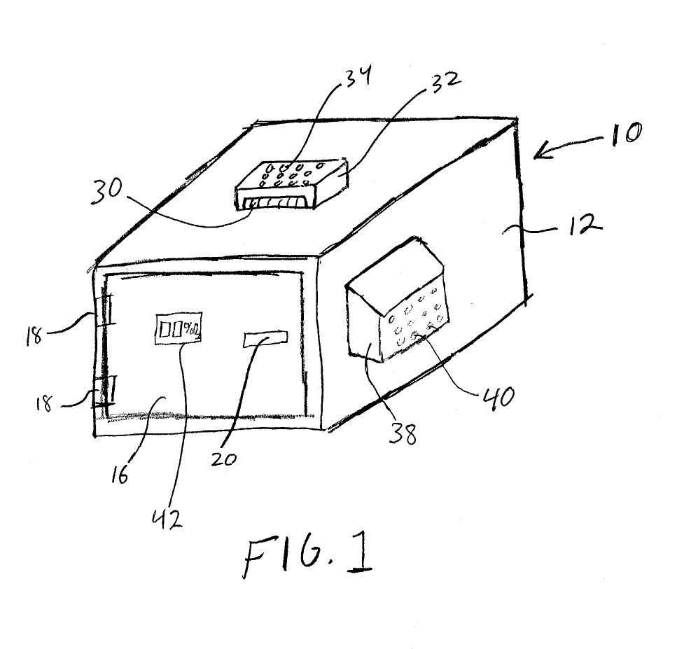

Referring first to FIGS. 1 through 3, a storage device 10 for oxidizable materials is shown. Storage device 10 includes a plurality of outer walls 12 defining a storage chamber 14. Storage chamber 14 may be of substantially any shape, for example, square, rectangular, cylindrical, trapezoidal, cookie jar-shaped, thermos-shaped, etc., by varying the configuration of outer walls 12, as should be readily apparent to those skilled in the art. A rectangular shape, however, is preferred for ease of construction and use, as shown in the Figures. Storage chamber 14 provides a convenient place to store oxidizable objects.

Access to the interior of storage chamber 14 is provided through door 16 utilizing hinges 18 and a handle mechanism 20 which is known in the art. Any satisfactory door and handle means may be used to access the interior portion of storage chamber 14 while providing a reasonably air tight seal between the exterior and interior. As such, and because such door and handle means are known in the art, a detailed description thereof is not presented herein. However, it should be noted that it is preferable, although not necessary, that door 16 comprise substantially an entire side of storage chamber 14 and that hinges 18 are positioned accordingly, such as is the case with a typical microwave oven. This arrangement is preferable so as to allow unrestricted access to the interior of storage chamber 14, and to allow off-gasses (which may occur particularly when fresh fruits or vegetables are stored) to exit storage chamber 14 through door 16 when opened.

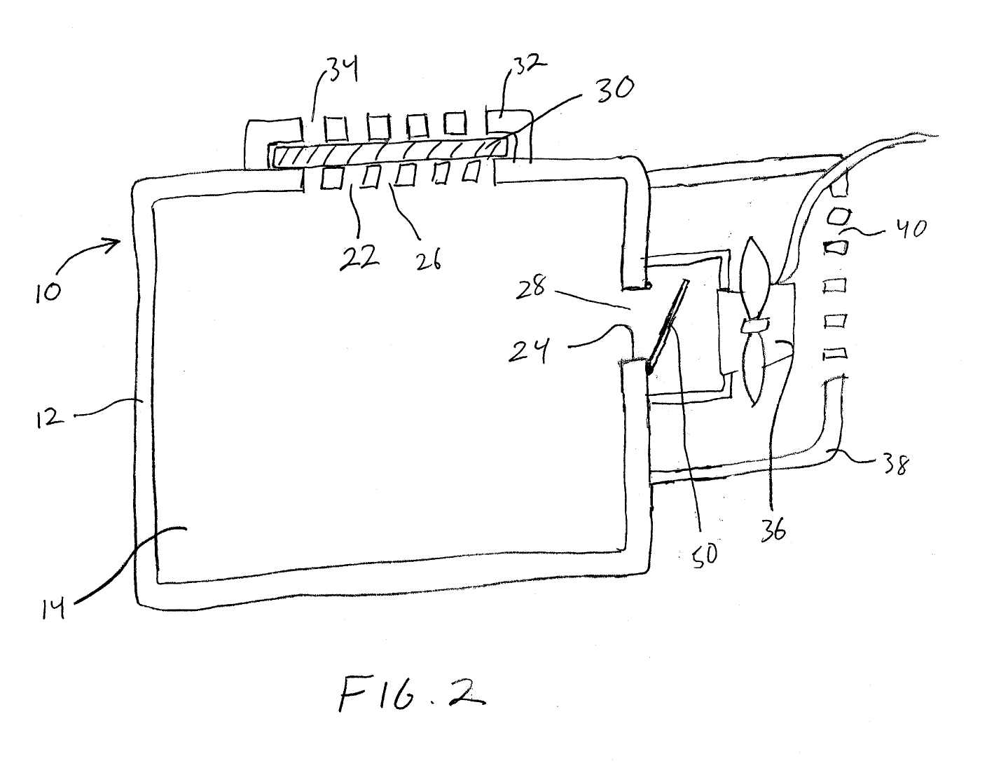

An inlet opening 22 and an outlet opening 24 pass through outer walls 12 in order to create inlet fluid passage 26 and outlet fluid passage 28 respectively between storage chamber 14 and the atmosphere. Inlet opening 22 and outlet opening 24 may pass through the same outer wall 12, or through different outer walls 12 (as shown in the Figures). Moreover inlet opening 22 and outlet opening 24 may comprise a single opening (as shown in FIG. 2 with respect to outlet opening 24) or a plurality of openings (as shown in FIG. 2 with respect to inlet opening 22).

Disposed within inlet fluid passage 26 is a differentially permeable membrane 30. Differentially permeable membrane 30 is formed from a material which allows one or more selected gases to differentially pass therethrough, while inhibiting oxygen from doing the same. As the normal atmosphere contains almost 80% nitrogen (which does not typically deleteriously affect oxidizable materials), differentially permeable membrane 30 is preferably formed from a material which allows nitrogen to differentially pass therethrough, while inhibiting oxygen from doing the same.

However, it should also be noted that differentially permeable membrane 30 may be formed from a material which allows gases other than, or in addition to, nitrogen to differentially pass therethrough. For example, if carbon dioxide would not adversely affect the oxidizable materials to be stored within storage chamber 14, differentially permeable membrane 30 may be formed from a material which allows both nitrogen and carbon dioxide to pass therethrough, while inhibiting oxygen from doing the same.

It should also be noted that differentially permeable membrane 30 may take any of numerous forms. For example, FIGS. 1 and 2 show differentially permeable membrane 30 as taking the form of a substantially flat cartridge or sheet of material for the sake of simplicity. When such is the case, a membrane holder 32 may be provided which allows differentially permeable membrane 30 to be easily slid in or out, which facilitates replacement of differentially permeable membrane 30 should such be required. Membrane holder 32 includes at least one opening 34 therein for allowing air to enter therethrough to reach differentially permeable membrane 30. However, as will be understood by those skilled in the art, differentially permeable membranes having a substantially flat configuration are not currently widely employed.

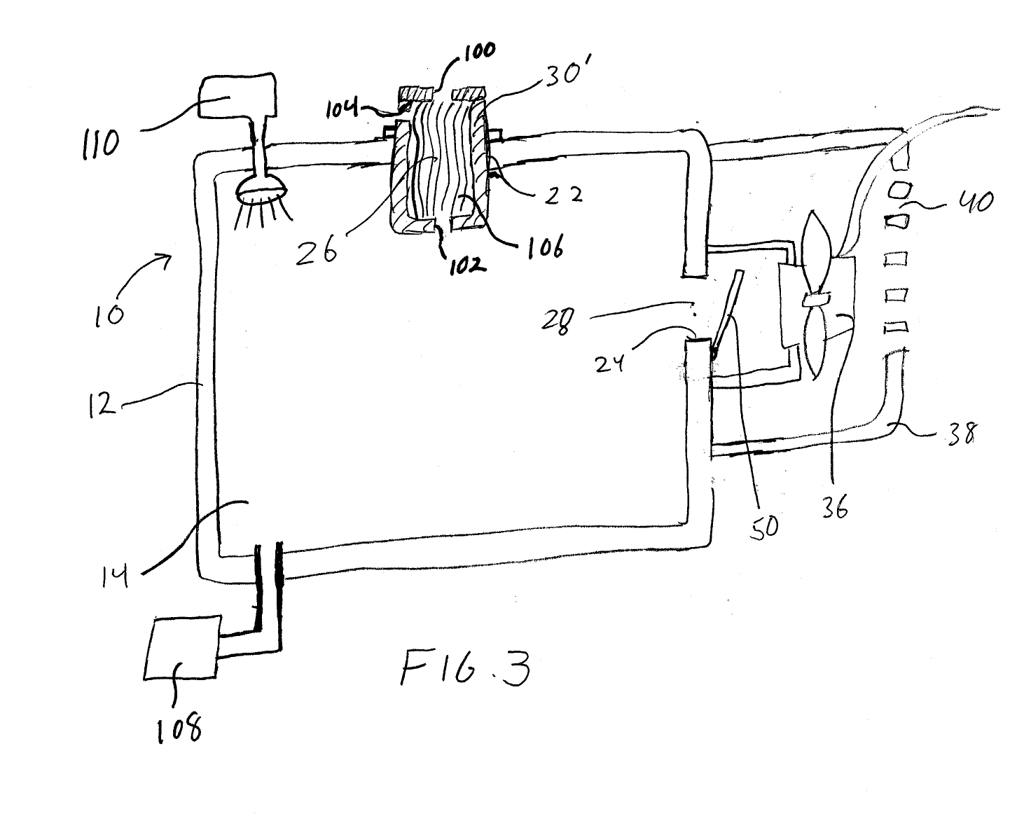

Rather, and referring specifically now to FIG. 3, differentially permeable membrane 30′, according to currently existing technology, preferably takes the form of a cylindrical cartridge or the like. Such a cartridge typically includes an inlet 100 for receiving gasses to be differentially separated, an outlet 102 for passing through the selected gas or gasses which are allowed to pass, and a vent 104 for returning the selected gas or gasses which are not allowed to pass to the original volume of gasses (whether it be the atmosphere or the storage chamber 14). Located within the cartridge are a plurality of hollow fibers 106 which act to separate and direct appropriate gasses to either outlet 102 or vent 104. Because such cartridges are known to those skilled in the art, and readily available on the market (for example, from MEDAL L.P. of Newport, Del.), a more detailed description of such cartridges is not presented herein. As should be understood by those skilled in the art, other configurations for differentially permeable membrane 30 are also possible.

Disposed adjacent to outlet opening 24 within outlet fluid passage 28 is an evacuator 36, for drawing gases out of storage chamber 14. Evacuator 36 may take the form of, for example, a fan, a compressor or a pump. However, it should be understood that a relatively powerful compressor, such as is used in refrigeration cycle systems, is not required. It should also be understood that it is not necessary for there to be a strong vacuum maintained within storage chamber 14. All that is necessary is an evacuator 36 powerful enough to remove gasses from storage chamber 14 and allow the selected gas or gasses (e.g., nitrogen, carbon dioxide, etc.) to differentially pass through differentially permeable membrane 30. A housing 38 may be provided to house evacuator 36, which housing includes at least one opening 40 passing therethrough in order to allow gasses evacuated from storage chamber 14 to be passed to the atmosphere.

A gauge or oxygen meter 42 may optionally be provided to monitor the percentage of oxygen content within storage chamber 14. Although not required, such a gauge 42 may allow a user or manufacturer to verify that the oxygen content of storage chamber 14 is within a desired range. Moreover, gauge 42 may be used to selectively switch evacuator 36 on or off depending upon the oxygen content of storage chamber 14 in order to conserve energy. For example, when the oxygen content within storage chamber 14 is above a desired value, evacuator 36 may be turned on, and when the oxygen content within storage chamber 14 is below the desired value, evacuator 36 may be turned off. Alternately, evacuator 36 may continuously run.

A one-way check valve 50 may also be disposed within outlet fluid passage 28 in order to inhibit oxygen-containing air from entering storage chamber 14 therethrough. As should be understood by those skilled in the art, such a check valve 50 is particularly desirable when evacuator 36 is allowed to be turned off. However, a check valve 50 may be desirable in any event, such that in the case of a power failure or the like, the evacuator is unintentionally turned off.

In operation, storage device 10 operates by removing gasses from storage chamber 14 through outlet fluid passage 28, while allowing a selected gas or gases present in the atmosphere (e.g., nitrogen, carbon dioxide, etc.) to be drawn into storage chamber 14 through differentially permeable membrane 30 located within inlet fluid passage 26. Thus, even if storage chamber 14 initially contains some oxygen, for example, as would be introduced when door 16 is opened to gain access to storage chamber 14, the content of oxygen within storage chamber 14 would be gradually decreased as the gasses within storage chamber 14 (which include the oxygen) are evacuated, and replaced with substantially oxygen free gasses.

By employing the above-described storage device, the atmosphere within storage chamber 14 may be controlled to replace normal atmospheric content of gas (i.e., approximately 80% nitrogen and 20% oxygen) with an atmosphere with considerably less oxygen.

Because storage device 10 preferably incorporates a fan, pump or simple compressor instead of a vacuum pump or refrigeration compressor, the device is more energy efficient than known refrigeration and vacuum systems.

Referring again to FIG. 3, storage device 10 may further include additional optional elements to further enhance the storage capabilities thereof. For example, if storage device is to be used to store certain items, such as certain foods which benefit from moisture, a humidifier 108 may be provided to provide moisture to the gasses within storage chamber 14. Further, a device 110 for killing undesirable microbes, such as an ultraviolet light or an anti-microbial spray, may also be provided.

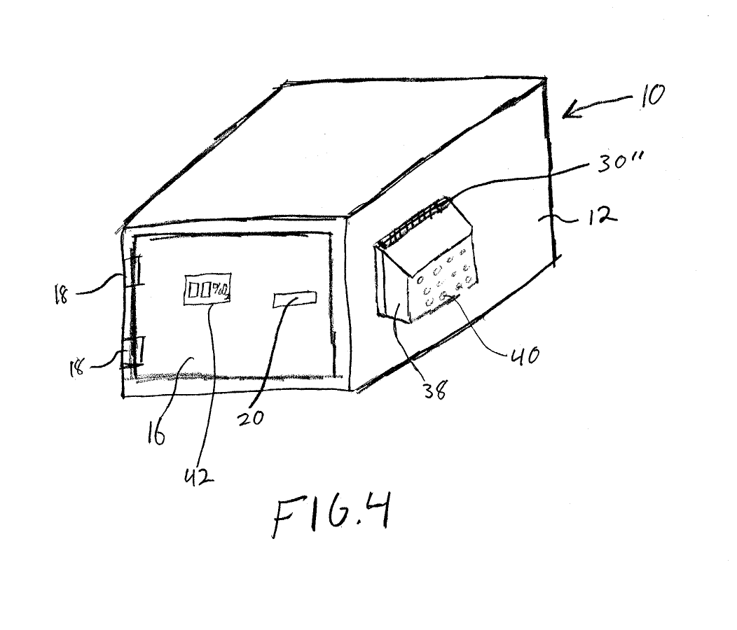

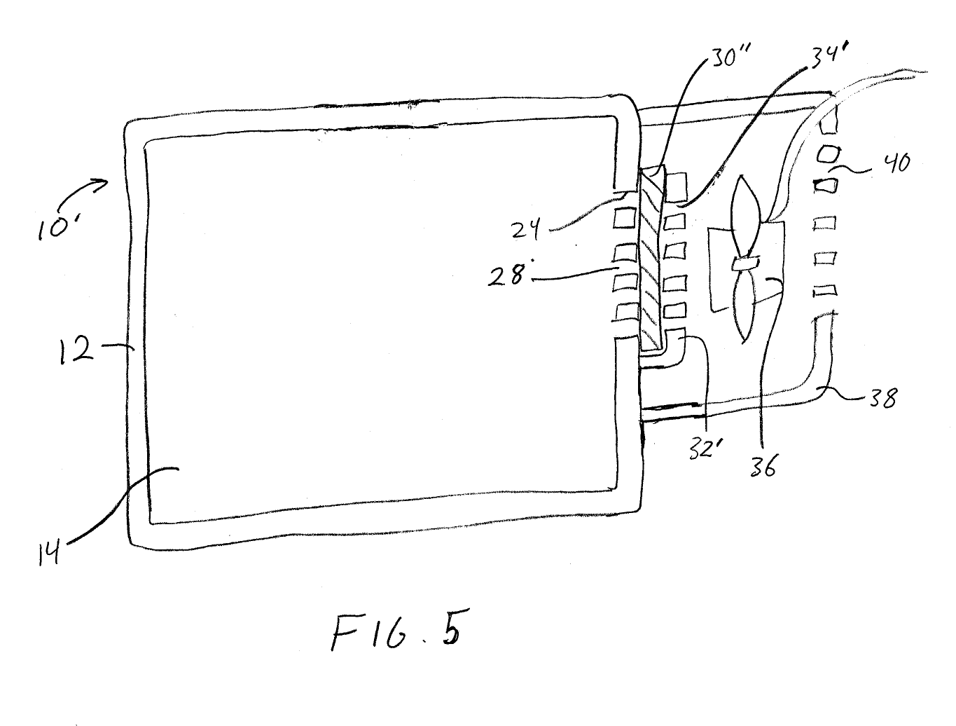

Referring now to FIGS. 4 and 5, another embodiment of a storage device 10′ in accordance with the present invention is shown. This embodiment is similar to the embodiments discussed above, with the main exception being that a differentially permeable membrane 30″ which allows at least oxygen to differentially pass therethrough, while inhibiting at least one gas (preferably at least nitrogen) from doing the same. In this embodiment, no inlet passage is provided, and differentially permeable membrane 30″ is disposed within outlet fluid passage 28. As with the embodiments discussed above, differentially permeable membrane 30″ may take numerous forms, such as a substantially flat cartridge or sheet of material, or a cylindrical cartridge. A membrane holder 32′ may be provided which allows differentially permeable membrane 30″ to be easily slid in or out, which facilitates replacement of differentially permeable membrane 30″ should such be required. Membrane holder 32′ includes at least one opening 34′ therein for allowing oxygen (and any other gases) passing through differentially permeable membrane 30″ to reach the atmosphere.

In operation, this embodiment of storage device 10 operates by removing oxygen from storage chamber 14 through outlet fluid passage 28, while inhibiting a selected gas or gases initially present within storage chamber 14 (e.g., nitrogen) to be withdrawn through differentially permeable membrane 30″ located within outlet fluid passage 28. Thus, even if storage chamber 14 initially contains some oxygen, for example, as would be introduced when door 16 is opened to gain access to storage chamber 14, the content of oxygen within storage chamber 14 would be gradually decreased as it is evacuated through differentially permeable membrane 30″.

The present invention, therefore, provides a storage device for oxidizable materials which controls the gaseous content of a storage volume of the device in order to prolong storage life, to allow storage of currently difficult-to-store materials, to allow storage of non-refrigeratable foods and to inhibit the ripening and/or deterioration of certain foods without adversely affecting flavor, which is relatively simple in design, lightweight and inexpensive to produce, which operates quietly and does not generate a great amount of heat, which is appropriate for storing substantially all oxidizable food items and non-food items, which is energy efficient and therefore relatively inexpensive to operate and environmentally friendly, which does not risk implosion, and which does not require servicing and/or the replacement of components on a regular basis.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A storage device for the preservation of oxidizable materials comprising:
a storage chamber enclosing a storage space where oxidizable materials may be placed, said storage chamber having at least one fluid passage therethrough from said storage space to atmosphere;
at least one differentially permeable membrane disposed within at least one of the fluid passages through said storage chamber, said differentially permeable membrane allowing at least one selected gas to pass therethrough while inhibiting at least one other selected gas from passing therethrough;
an evacuator for evacuating oxygen from within said storage chamber through at least one of the fluid passages to the atmosphere; and
wherein the level of oxygen within said storage chamber is reduced relative to the level of oxygen in the atmosphere.

2. The storage device of claim 1 wherein:
said at least one fluid passage comprises an inlet fluid passage and an outlet fluid passage;
said differentially permeable membrane allows at least one gas to pass therethrough while inhibiting at least oxygen from passing therethrough;
said differentially permeable membrane is disposed within the inlet fluid passage;
said evacuator evacuates gasses, including oxygen, from within said storage chamber through the outlet fluid passage, and
gasses other than oxygen replace the gasses evacuated by said evacuator by passing through said differentially permeable membrane disposed in the inlet fluid passage.

3. The storage device of claim 2 further comprising a one-way check valve disposed within the outlet fluid passage to inhibit gasses from flowing into said storage chamber through the outlet fluid passage.

4. The storage device of claim 2 wherein said differentially permeable membrane allows at least nitrogen to pass therethrough while inhibiting at least oxygen from passing therethrough.

5. The storage device of claim 1 wherein:
said at least one fluid passage comprises an outlet fluid passage;
said differentially permeable membrane allows at least oxygen to pass therethrough while inhibiting at least one other gas from passing therethrough;
said differentially permeable membrane is disposed within the outlet fluid passage; and
said evacuator evacuates at least oxygen from within said storage chamber through said differentially permeable membrane disposed in the outlet fluid passage.

6. The storage device of claim 5 wherein said differentially permeable membrane allows at least oxygen to pass therethrough while inhibiting at least nitrogen from passing therethrough.

7. The storage device of claim 1 wherein said evacuator comprises a fan.

8. The storage device of claim 1 wherein said evacuator comprises a compressor.

9. The storage device of claim 1 wherein said evacuator comprises a pump.

10. The storage device of claim 1 wherein said differentially permeable membrane comprises a substantially flat sheet of material or cartridge.

11. The storage device of claim 1 wherein said differentially permeable membrane comprises a substantially cylindrical cartridge.

12. The storage device of claim 11 wherein said differentially permeable membrane comprises a substantially cylindrical cartridge having a plurality of hollow fibers disposed therein.

13. The storage device of claim 1 further comprising a gauge for monitoring the level of oxygen within said storage chamber.

14. The storage device of claim 13 wherein said gauge is used to selectively switch said evacuator on or off depending upon the oxygen level within said storage chamber.

15. The storage device of claim 1 further comprising a humidifier for providing moisture to the gasses within said storage chamber.

16. The storage device of claim 1 further comprising a device or system for killing undesirable microbes within said storage chamber.

17. A storage device for the preservation of oxidizable materials comprising:
a storage chamber enclosing a storage space where oxidizable materials may be placed, said storage chamber having an inlet fluid passage and an outlet fluid passage therethrough from said storage space to atmosphere;
at least one differentially permeable membrane disposed within the inlet fluid passage through said storage chamber, said differentially permeable membrane allowing at least nitrogen to pass therethrough while inhibiting at least oxygen from passing therethrough;
an evacuator for evacuating gasses, including oxygen, from within said storage chamber through the outlet fluid passage to the atmosphere;
a one-way check valve disposed within the outlet fluid passage to inhibit gasses from flowing into said storage chamber through the outlet fluid passage; and
wherein gasses other than oxygen replace the gasses evacuated by said evacuator by passing through said differentially permeable membrane disposed in the inlet fluid passage such that the level of oxygen within said storage chamber is reduced relative to the level of oxygen in the atmosphere.

18. The storage device of claim 17 wherein said evacuator comprises a fan.

19. The storage device of claim 17 wherein said evacuator comprises a compressor.

20. The storage device of claim 17 wherein said evacuator comprises a pump.

21. The storage device of claim 17 wherein said differentially permeable membrane comprises a substantially flat sheet of material or cartridge.

22. The storage device of claim 17 wherein said differentially permeable membrane comprises a substantially cylindrical cartridge.

23. The storage device of claim 22 wherein said differentially permeable membrane comprises a substantially cylindrical cartridge having a plurality of hollow fibers disposed therein.

24. The storage device of claim 17 further comprising a gauge for monitoring the level of oxygen within said storage chamber.

25. The storage device of claim 24 wherein said gauge is used to selectively switch said evacuator on or off depending upon the oxygen level within said storage chamber.

26. The storage device of claim 17 further comprising a humidifier for providing moisture to the gasses within said storage chamber.

27. The storage device of claim 17 further comprising a device or system for killing undesirable microbes within said storage chamber.

28. A storage device for the preservation of oxidizable materials comprising:
a storage chamber enclosing a storage space where oxidizable materials may be placed, said storage chamber having an outlet fluid passage therethrough from said storage space to atmosphere;
at least one differentially permeable membrane disposed within the outlet fluid passage through said storage chamber, said differentially permeable membrane allowing at least oxygen to pass therethrough while inhibiting at least nitrogen from passing therethrough;
an evacuator for evacuating at least oxygen from within said storage chamber through said differentially permeable membrane disposed in the outlet fluid passage such that the level of oxygen within said storage chamber is reduced relative to the level of oxygen in the atmosphere.

29. The storage device of claim 28 wherein said evacuator comprises a fan.

30. The storage device of claim 28 wherein said evacuator comprises a compressor.

31. The storage device of claim 28 wherein said evacuator comprises a pump.

32. The storage device of claim 28 wherein said differentially permeable membrane comprises a substantially flat sheet of material or cartridge.

33. The storage device of claim 28 wherein said differentially permeable membrane comprises a substantially cylindrical cartridge.

34. The storage device of claim 33 wherein said differentially permeable membrane comprises a substantially cylindrical cartridge having a plurality of hollow fibers disposed therein.

35. The storage device of claim 28 further comprising a gauge for monitoring the level of oxygen within said storage chamber.

36. The storage device of claim 35 wherein said gauge is used to selectively switch said evacuator on or off depending upon the oxygen level within said storage chamber.

37. The storage device of claim 28 further comprising a humidifier for providing moisture to the gasses within said storage chamber.

38. The storage device of claim 28 further comprising a device or system for killing undesirable microbes within said storage chamber.
